(19) United States
(12) Patent Application Publication
(10) Pub. No.: US 2010/0077025 A1
(43) Pub. Date: Mar. 25, 2010

(54) WORKFLOW AUTOMATION & REQUEST PROCESSING

(75) Inventors: Charles T. Macurda, Charlotte, NC (US); Scott Margolis, Coppell, TX (US); Daniel Choi, Charlotte, NC (US); Jake Carter, Indian Land, SC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 12/534,579

(22) Filed: Aug. 3, 2009

Related U.S. Application Data
(60) Provisional application No. 61/088,216, filed on Aug. 12, 2008.

(51) Int. Cl. G06F 15/16; G06F 15/173

(52) U.S. Cl. 709/203; 709/223

(57) ABSTRACT

Methods and systems for transparently and seamlessly integrating various process and project management systems into a single system with a single point of entry for all users are disclosed. The system creates a web, tying together each of the independent systems to provide an intelligent, end-to-end workflow management system.

This application claims priority from U.S. Provisional Application Ser. No. 61/088,216, filed Aug. 12, 2008, which is herein incorporated by reference in its entirety.

### TECHNICAL FIELD

Aspects of the disclosure generally relate to automated workflow in an environment with varied resources requiring varied interfaces.

### BACKGROUND

Large corporations often have many disparate systems, applications and access points for various reasons. Some corporations go through many mergers and acquisitions over time and need to continue to support the systems at each of the different entities that merge or are acquired. Each system and application may provide different users with similar functionality while at the same time requiring different input and resulting in different output.

One example of a task that systems and applications in a corporate environment may be designed to accomplish is managing requests for resources and associated workflows. Examples of such resources may include equipment, technology resources (e.g. application hosting, data storage, etc.), and human resources.

Currently, management of workflow may be done on commercially available systems or customized proprietary systems. These systems have varying levels of interoperability and cohesiveness. In general however, the disparate systems need to be operated and managed separately from each other. This may require users to interface with multiple systems and access points and potentially cause uncertainty regarding the differences between offerings. Moreover, maintaining different systems does not allow for adequate tracking of the status of a request throughout its lifecycle, may lead to longer time to completion of requests, and may require manual and duplicate work and processes. Additionally, all of these inefficiencies may lead to extra expense to manage these various systems.

### BRIEF SUMMARY

The following presents a simplified summary of the disclosure in order to provide a basic understanding of some aspects. It is not intended to identify key or critical elements of the invention or to delineate the scope of the invention. The following summary merely presents some concepts of the disclosure in a simplified form as a prelude to the more detailed description provided below.

Methods and systems are disclosed for transparently and seamlessly integrating various process and project management systems into a single system with a single point of entry for all users. The system creates a web, tying together each of the independent systems to provide an intelligent, end-to-end workflow management system. The system provides for the integration of all technologies needed to complete service requests from order of the service to fulfillment of the service request.

Aspects of the disclosure generally relate to automated workflow in an environment with varied resources requiring varied interfaces.

### BRIEF DESCRIPTION OF THE DRAWINGS

FIG. 1 illustrates a high-level computing environment in which one or more aspects described herein may be implemented.

FIG. 2 illustrates a high-level computing environment in which one or more aspects described herein may be implemented.

FIG. 3 is a high level flow chart illustrating an embodiment of a process for automating workflow and processing and managing service requests.

FIG. 4 is a flow chart illustrating an embodiment of a process for selecting and submitting an item from a service catalog.

FIG. 5 is a flow chart illustrating an embodiment of a process for tracking a service request.

FIG. 6 is a flow chart illustrating an embodiment of a process for reporting the status of a service request.

FIG. 7 is a flow chart illustrating an embodiment of a process for reviewing and approving a service request.

FIG. 8 is a flow chart illustrating an embodiment of a process for assigning a service request.

FIG. 9 is a flow chart illustrating an embodiment of a process for executing and closing a service request.

### DETAILED DESCRIPTION

Overall Computing Network

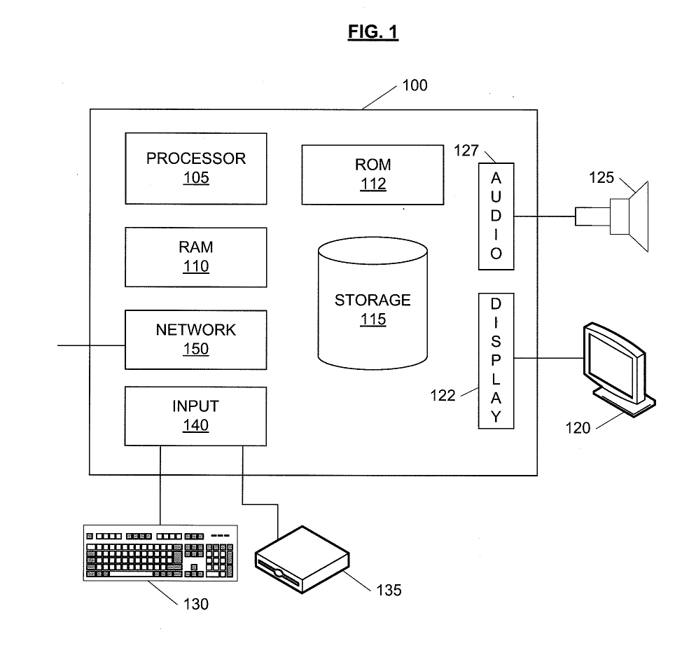

FIG. 1 illustrates a high-level computing environment in which one or more aspects described herein may be implemented. A computing device such as computer 100 may house a variety of components for inputting, outputting, storing and processing data. Computer 100 may include desktop computers, laptop computers, ultra mobile PCs, servers and the like. Processor 105 may perform a variety of tasks including executing one or more applications, retrieving data from a storage device such as storage 115 and/or outputting data to a device such as display 120. Processor 105 may be connected to Random Access Memory (RAM) module 110 in which application data and/or instructions may be temporarily stored. Computer 100 may further include Read Only Memory (ROM) 112 which allows data stored thereon to persist or survive after computer 100 has been turned off. ROM 112 may be used for a variety of purposes including for storage of computer 100's Basic Input/Output System (BIOS). ROM 112 may further store date and time information so that the information persists even through shut downs and reboots. In addition, storage 115 may provide long term storage for a variety of data including applications and data files. Storage 115 may include any of a variety of computer readable mediums such as disc drives, optical storage mediums, magnetic tape storage systems, flash memory and the like. In one example, processor 105 may retrieve an application from storage 115 and temporarily store the instructions associated with the application RAM module 110 while the processor 105 is executing the application.

Computer 100 may output data through a variety of components and devices. As mentioned above, one such output device may be display 120. Another output device may include an audio output device such as speaker 125. Each output device 120 and 125 may be associated with an output adapter such as display adapter 122 and audio adapter 127, which translates processor instructions into corresponding audio and video signals. In addition to output systems, computer 100 may receive and/or accept input from a variety of input devices such as keyboard 130, storage media drive 135 and/or microphone (not shown). As with output devices 120 and 125, each of the input devices 130 and 135 may be associated with an adapter 140 for converting the input into computer readable/recognizable data. In one or more instances, a device such as media drive 135 may act as both an input and output device allowing users to both write and read data to and from the storage media (e.g., DVD-R, CD-RW, etc.).

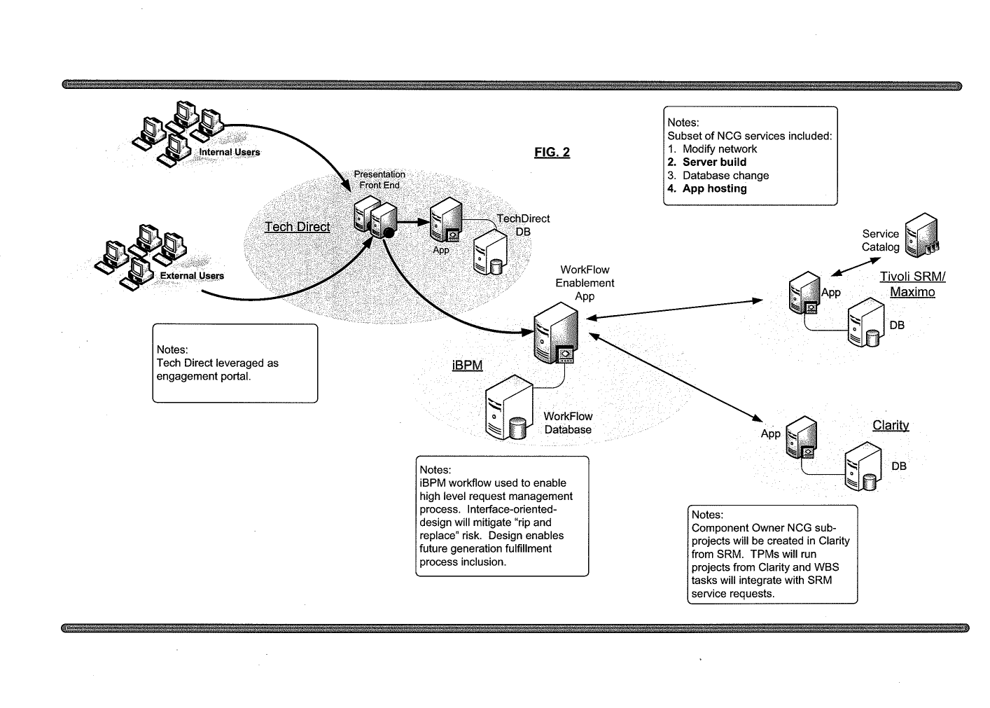

Computer 100 may further include one or more communication components for receiving and transmitting data over a network. Various types of networks include cellular networks, digital broadcast networks, Internet Protocol (IP) networks and the like. Computer 100 may include adapters suited to communicate through one or more of these networks. In particular, computer 100 may include network adapter 150 for communication with one or more other computer or computing devices over an IP network (e.g., see FIG. 2). In one example, adapter 150 may facilitate transmission of data such as electronic mail messages and/or financial data over a company or organization's network. In another example, adapter 150 may facilitate transmission or receipt of information from a world wide network such as the Internet. Adapter 150 may include one or more sets of instructions relating to one or more networking protocols. For example adapter 150 may include a first set of instructions for processing IP network packets as well as a second set of instructions associated with processing cellular network packets. In one or more arrangements, network adapter 150 may provide wireless network access for computer 100.

One of skill in the art will appreciate that computing devices such as computer 100 may include a variety of other components and is not limited to the devices and systems described in FIG. 1.

System

Embodiments of the invention relate to systems and methods for integrating various systems and applications to provide an end-to-end, workflow system, allowing information to intelligently flow from one step or application node to the next with the assistance of a neural network. Some embodiments of the invention integrate order-to-fulfillment technologies to provide a neural network that provides the seamless end-to-end workflow system. Such an order-to-fulfillment workflow management system may provide many benefits. Aspects of the invention may eliminate manual intervention between systems, increase the speed of delivery, and provide visibility into the status of requests to all users. Some aspects of the invention create a web between existing applications, which may enable process owners to build their own processes and to plug them in to the system, allowing the system to intelligently manage the process workflow.

There may be any number of users accessing the system. FIG. 2 depicts an exemplary operating environment in one embodiment of the invention. As can be seen in FIG. 2, the users may be either internal or external to the network where the system resides. In alternative embodiments, various components of the system may be distributed over the Internet or other network and each component may be in the same network as or a different network than that of any other component.

Aspects of the invention may include a single point of access, or portal, for requesting resources. In the exemplary embodiment depicted in FIG. 2, the portal is identified as Tech Direct. In some embodiments, the portal may be presented to the user via a web page, a software application or applet running on a user's machine, a software application running on a remote machine, or any other well known method or combination of methods. In certain aspects, the server running the portal or the machine to which a user connects to the Tech Direct system may be connected to an application server and/or a database. In other embodiments, the server running the portal may be connected to the application server, which is also connected to a database. In some embodiments, the server running the portal may be connected, directly or indirectly, to a service catalog. The portal may provide an interface into the service catalog.

The service catalog depicted in FIG. 2 may be a database or other computer readable medium or data structure comprising service request options available to a user of the system. Alternatively, service catalog may be a file (XML, spreadsheet, text file, etc.). Regardless of the method of storage of the information in the service catalog and the location of the service catalog, a user may be presented with the information contained in the service catalog through the portal. Additional information may be needed from the user requesting an item from the service catalog. If additional information is needed, certain embodiments may include an application or module to obtain that information in. After the additional information is obtained, the information and request may be passed to the workflow manager (also referred to as a business process manager). In other embodiments, the request and associated information may be passed to the workflow manager and the additional necessary information may be managed and obtained by the workflow manager.

Other aspects of the invention may include a centralized workflow manager or business process manager that may automate the workflow process once a request enters the system through the single point of access. Depending upon the request, and the associated necessary resources and tasks, the business process manager may automatically prompt the appropriate user(s) and either ask for necessary information or inform a user of certain tasks that the user must complete. Once tasks are completed or information is received, the business process manager may then prompt the next appropriate user(s) of the information needed or task(s) that must be completed. This process may continue until the workflow is completed.

In some embodiments, the workflow enablement application and/or the business process manager may be connected to other applications or databases that assist in the management of the project and process workflow. These applications and databases may be commercially available products such as IBM's Clarity and C.A.'s Maximo products, custom-developed and/or proprietary applications or databases, or some combination of the two. In certain embodiments, these applications and or databases may also be connected to the service catalog.

Process

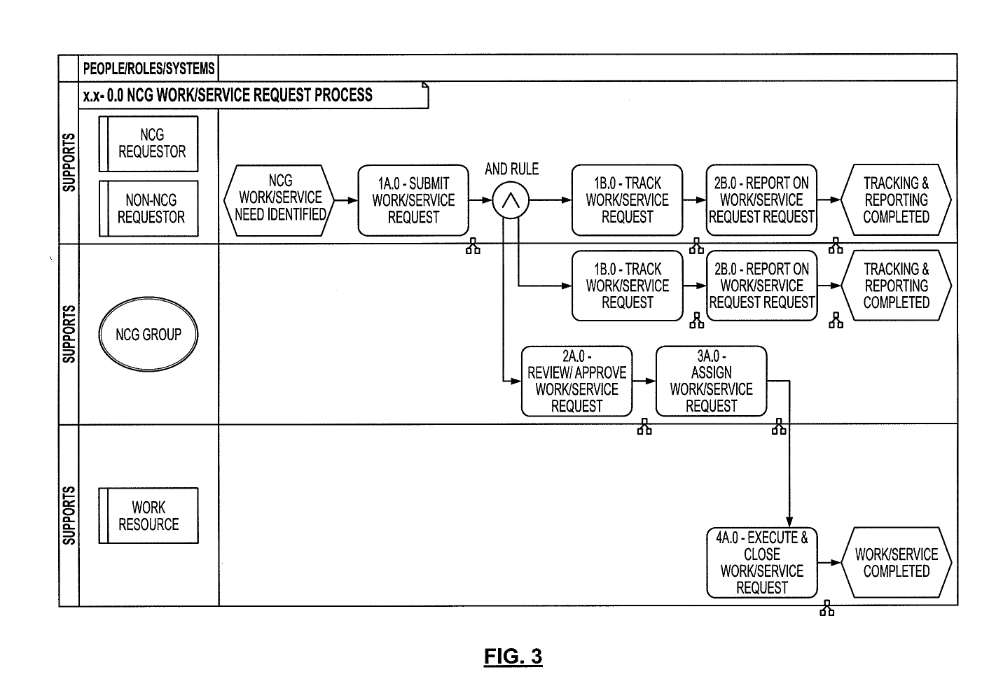

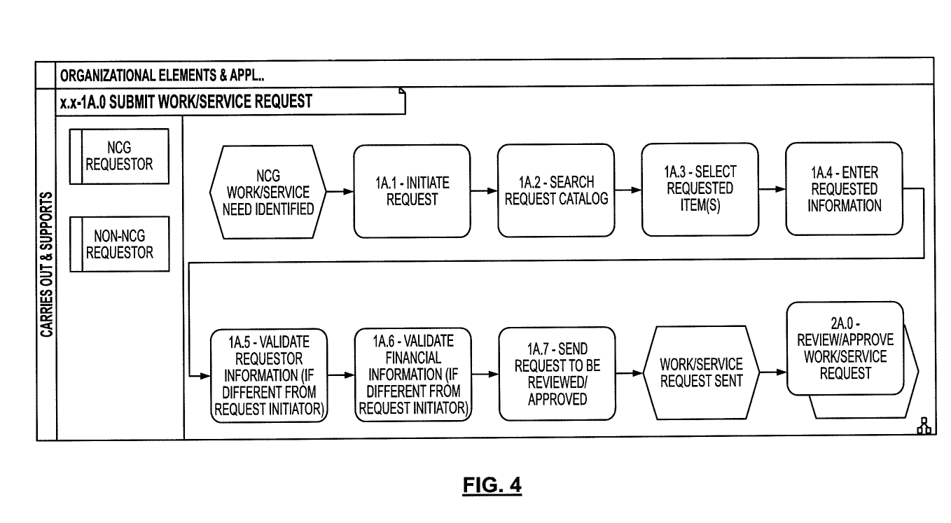

FIG. 3 is a high level flow chart illustrating an embodiment of a process for automating workflow and processing and managing service requests. In the first step shown in FIG. 3, a user may select and submit an item (step 1A.0) from the service catalog, using the Tech Direct portal presented to the user. An exemplary process for this step is depicted in FIG. 4. As can be seen from the chart, once a service need is identified, a user may initiate a request for that service (step 1A.1). In this instance, the web page or application that the user is directed to may provide an interface into the service catalog. The user may then search the service catalog (step 1A.2) for the service requests relevant to that user and, upon finding the desired service, select that item (step 1A.3). Depending upon the request item selected by the user, the system may use the business logic associated with that item to prompt the user for further information specific to the service item requested that is necessary to initiate the workflow for the request. In some embodiments, the system may accept the further input from the user. The system may validate or verify input received from the user. The user may then enter the requested information (step 1A.4) and the system may validate the identity of the user (step 1A.5) and the financial information (step 1A.6) if the user is different than the user who initiated the request. The process of requesting further information may be repeated any number of times depending upon the item requested by the user and the business logic and process associated with that item. In some embodiments, the system may also provide information to the user about the availability of aspects of the service request. This may help the user initiating the request to be able to estimate the feasibility of completing the request and the time to completion of the request. Finally, the system may send the request along to the workflow manager to be reviewed, approved and executed (step 1A.7).

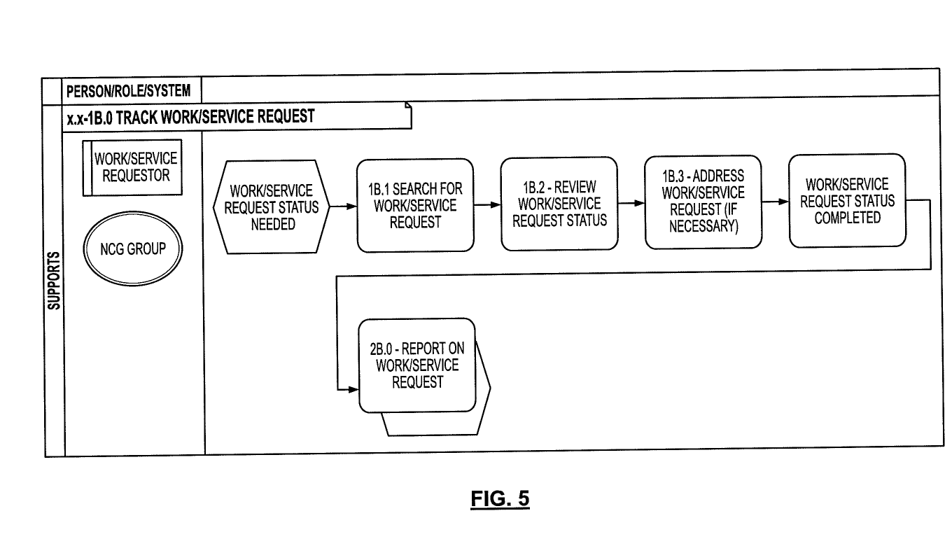

Once a user has selected and submitted an item (step 1A.0), the request has been submitted into the workflow execution engine and will be managed by the system. As can be seen in step 1B.0 in FIG. 3, some embodiments allow the requestor and/or a member of another group to track the service request. FIG. 5 is a drilldown of step 1B.0 of FIG. 3 and depicts exemplary steps that may occur during the tracking of a service request in some embodiments. When status of the service request is needed or desired, a user may search the system for the service request (step 1B.1), review the service request status (step 1B.2) and, if necessary, address the service request (step 1B.3).

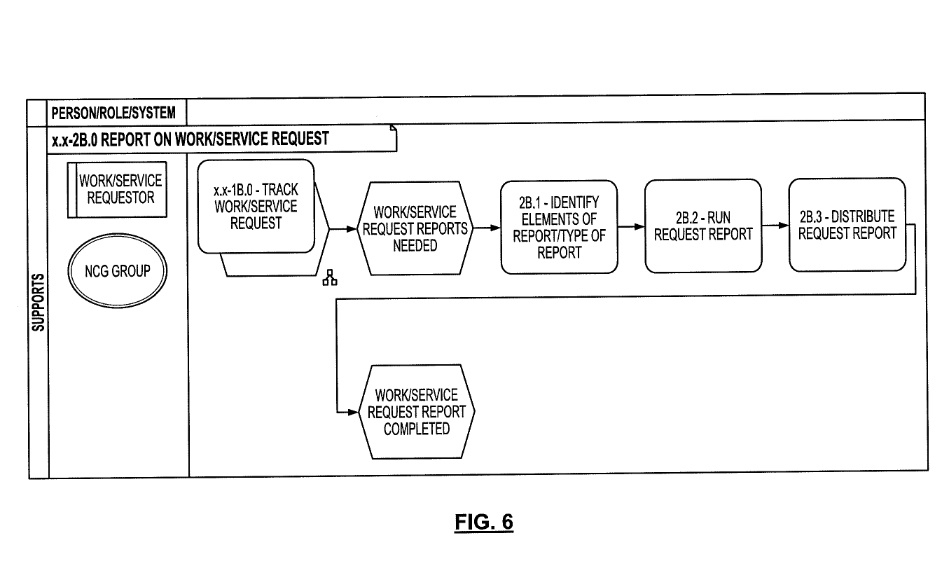

Additionally, some embodiments may allow a user to report on the service request as indicated by step 2B.0. FIG. 6 depicts one embodiment of a process for reporting on the status of a service request. When a user elects to run a report, the user may identify the elements of a report or type of report desired (step 2B.1). Once the desired report is defined, the user may then run a report on the service request (step 2B.2) and distribute the service request report (step 2B.3). In some embodiments, reports may include process analytics; i.e., reporting data on the process that is used including, for example, how long each step took, where bottlenecks may have occurred, and other data and statistics relevant to determining the effectiveness and efficiency of the process of completing a service request.

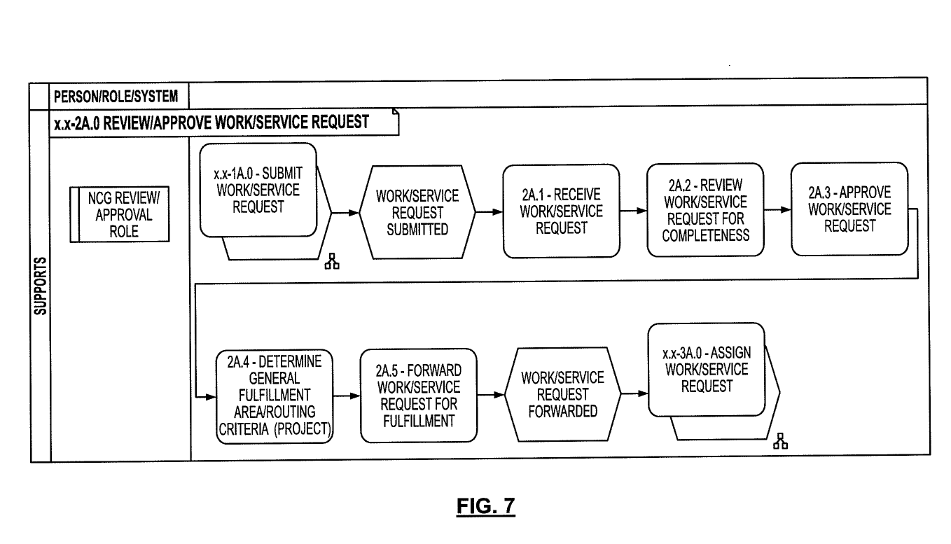

Upon submission of a service request, the service request may be reviewed and/or approved in step 2A.0. One exemplary embodiment of a process for reviewing and approving a service request is shown in FIG. 7. As can be seen in FIG. 7, the system may receive the service request (step 2A.1) and the service request may then be reviewed for completeness (step 2A.2). If the service request is deemed to be complete, the service request may be approved (step 2A.3). The system may then determine the criteria for routing and fulfilling the service request (step 2A.4). Once the routing and fulfillment criteria are determined, the system may forward the service request (step 2A.5).

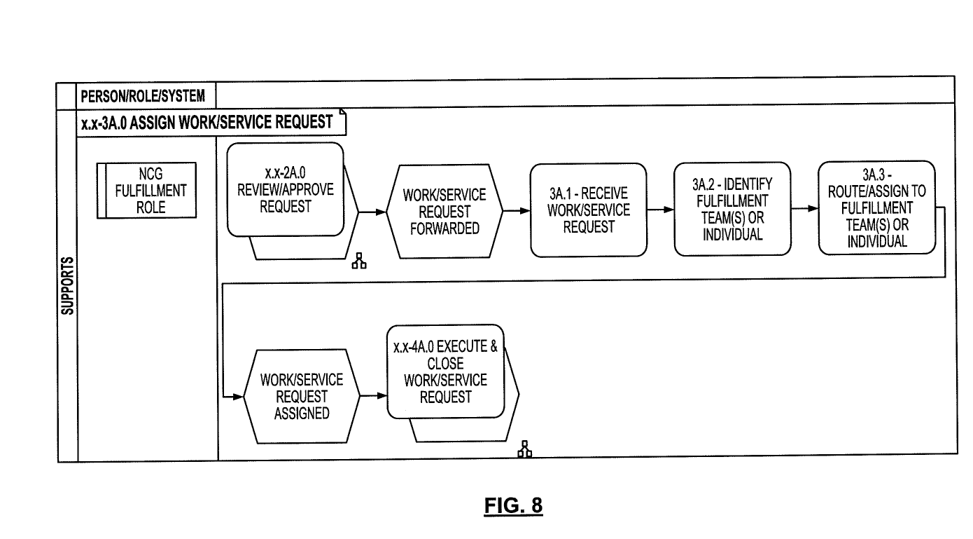

As seen in the embodiment depicted in FIG. 3, after the service request has been reviewed and approved in step 2A.0, the system may assign the service request in step 3A.0. FIG. 8 depicts an embodiment of an exemplary set of steps that may be part of assigning a service request. After the service request is received (step 3A.1), the system may identify the user(s) and/or team(s), systems, and applications that are necessary to fulfill the service request (step 3A.2). In some embodiment, the system may also determine where tasks and/or information need to be assigned and routed and route and assign the request to the appropriate team(s) and/or user(s) (step 3A.3).

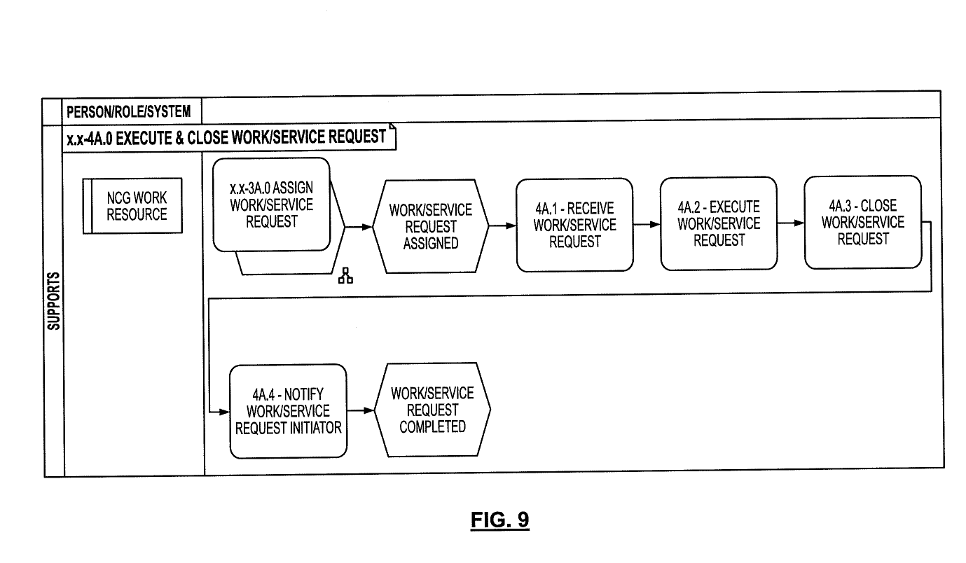

In the exemplary process shown in FIG. 3, depicting one embodiment of a method of the present invention, the final step in completing the service request is to execute and close the service request in step 4A.0. FIG. 9 shows process steps in one embodiment of the invention to execute and close the service request. After receiving the service request (step 4A.1), the service request is executed (step 4A.2) and closed (step 4A.3). When a service request is completed, the initiator of the service request is notified that the request is complete (step 4A.4).

The methods and systems disclosed herein can be carried out in various ways. The system may integrate multiple systems and/or steps into a single process workflow. Moreover, the neural network may provide intelligent management of the process workflow. Exemplary methods of prompting users (task owners) for action include sending the user an electronic message (e.g., email, SMS, or other electronic message) or some other indicator to inform that user of current tasks or steps that need to be completed (e.g. a “to do list”). Once each step is completed, the system may automatically initiate the subsequent step and inform subsequent user(s) of their task(s). For tasks that may be done simultaneously, the system may inform each user with pending tasks at the same time. The system can initiate subsequent steps that only depend on one preceding step as soon as the step is completed and initiate steps that depend on multiple preceding steps once all preceding steps are completed.

An exemplary set of steps that may occur in certain embodiments of the invention may start with the determination by a group within a corporation that the group needs a new application. The group may use the system to search the service catalog and request an engagement manager. The engagement manager may manage the relationship between the requesting group and a technology group. Subsequently, the engagement manager may use the system to request a technical project manager, who in turn may request a design team lead. The design team lead may then determine that certain computer hardware, application hosting, and technical development resources are needed. The design team lead may request these additional resources through the single, integrated system.

In some embodiments, the communication between systems and applications is done by formatting all transmitted data into a standard format, such as XML or a proprietary format. In alternative embodiments, modules may be used to translate data from one proprietary format to a standard format or to another proprietary format. In some embodiments, the neural network may provide communication between the application server and the workflow manager via webservices. The application server may make webservice calls to functions of the workflow manager that may, in turn, initiate downstream processes in other systems (e.g., document management systems, project management systems, process management systems, or other systems used to manage resources), sub-processes, database calls, system updates, external processes, third party vendor requests, or other tasks or steps.

Although not required, one of ordinary skill in the art will appreciate that various aspects described herein may be embodied as a method, a data processing system, or as a computer-readable medium storing computer-executable instructions. For example, a computer-readable medium storing instructions to cause a processor to perform steps of a method in accordance with aspects of the disclosure is contemplated. For example, aspects of the method steps disclosed herein may be executed on a processor on a computer 100. Such a processor may execute computer-executable instructions stored on a computer-readable medium.

While illustrative embodiments described herein embody various aspects are shown, it will be understood by those skilled in the art that the invention is not limited to these embodiments. Modifications may be made by those skilled in the art, particularly in light of the foregoing teachings. For example each of the elements of the aforementioned embodiments may be utilized alone or in combination or sub-combinations with the elements of the other embodiments. It will also be appreciated and understood that modification may be made without departing from the true spirit and scope of the present intention. The description is thus to be regarded as illustrative instead of restrictive on the present intention.

We claim:

1. A system for integrating order-to-fulfillment technologies comprising:
a user interface;
an application server configured to receive information from the user interface and display results to the user interface;
an electronic service catalog capable of connection with the application server, the service catalog comprising service request options available to a user of the system; and
an electronic workflow manager capable of connection with the application server, wherein the workflow manager is configured to:
receive, from the application server, information regarding a service requested by the user;
store the information regarding the requested service;
identify a plurality of steps that must be executed to complete the requested service;
identify a first step of the plurality of steps that must be executed;
initiate a process to handle the first step, including:
identifying an application needed to complete the first step; and
sending information necessary to complete the first step to the application;
receive notification of completion of the process from the application;
wherein communication between the application server and the workflow manager is enabled by webservices.

2. The system of claim 1, wherein the workflow manager is further configured to send the application server information regarding status of the service requested and wherein the application server is configured to receive information regarding the status of the service requested and display the information regarding the status to the user interface.

3. The system of claim 1, wherein the user interface comprises a webpage.

4. The system of claim 1, wherein the user interface comprises a screen generated by a software application.

5. The system of claim 1, wherein the workflow manager is further configured to
identify additional information that must be obtained;
identify a second user responsible for providing the additional information;
notify the second user of the service requested by the user; and
receive the additional information from the second user.

6. The system of claim 5, wherein notifying the second user comprises sending an electronic message to the user regarding the service requested.

7. The system of claim 1, wherein the first step comprises updating a system with at least some of the information received from the application server.

8. The system of claim 1, wherein the application comprises a project management system.

9. The system of claim 1, wherein the application comprises a process workflow system.

10. The system of claim 1, wherein the application comprises a document management system.

11. A method of automating end-to-end management of workflow comprising:
receiving a user request, the user request comprising information identifying a service request option required by a user;
storing the user request in a memory;
determining, using a processor, whether additional information is needed from the user;
obtaining additional information determined to be needed;
sending, via webservices, the user request and the additional information to an electronic business process manager;
identifying, using the processor, a task that needs to be completed in order to complete the service request;
identifying an application needed to complete the task; and
sending information necessary to complete the task to the application.

12. The method of claim 11, further comprising:
identifying a second task that needs to be completed in order to complete the service request;
identifying a second application needed to complete the second task; and
sending information necessary to complete the second task to the second application.

13. The method of claim 12, wherein the application and the second application are the same application.

14. The method of claim 11, further comprising receiving notification from the application that the task was completed.

15. The method of claim 11, further comprising:
identifying additional information that needs to be obtained to complete the service request; and
alerting a second user that additional information needs to be obtained.

16. A tangible computer readable medium configured to execute computer executable instructions for end-to-end workflow management, the computer executable instructions comprising:
receiving a request from a user, the request comprising information identifying a service request option required by that user;
determining, using a processor, whether additional information is needed from the user;
obtaining additional information determined to be needed;
sending, via webservices, the request and the additional information to a business process manager;
identifying, using the processor, a task that needs to be completed to complete the service request;
identifying an application needed to complete the task; and
sending information necessary to complete the task to the application.

17. The computer readable medium of claim 16, wherein the computer executable instructions further comprise:
receiving a request from the user regarding the status of the service request;
generating status information regarding the service request; and
sending the status information to the user.

18. The computer readable medium of 17, wherein sending the status information to the user comprises sending data to an application server via webservices.

19. The computer readable medium of claim 17, wherein the status information comprises an XML file.

20. The computer readable medium of claim 16, wherein the computer executable instructions further comprise:
identifying additional information that needs to be obtained to complete the service request; and
alerting a second user that additional information needs to be obtained.
